(19) United States
(12) Patent Application Publication
(10) Pub. No.: US 2018/0060898 A1
(43) Pub. Date: Mar. 1, 2018

(54) METHODS AND SYSTEMS FOR OPERATING A LOYALTY PROGRAM FOR A CONSUMER ASSOCIATED WITH A FIRST CURRENCY

(71) Applicant: Mastercard International Incorporated, Purchase, NY (US)

(72) Inventors: Geetika Sharma, New Delhi (IN); Charu Jain, Singapore (SG); Ankit Shreemal, Gurgaon (IN)

(21) Appl. No.: 15/691,034

(22) Filed: Aug. 30, 2017

(30) Foreign Application Priority Data
Aug. 30, 2016 (SG) 10201607204V

(51) Int. Cl. G06Q 30/02; G06Q 20/36; G06F 17/30

(52) U.S. Cl. CPC G06Q 30/0227; G06Q 20/36; G06Q 20/28; G06F 17/30377; G06F 17/30522; G06F 17/30876

(57) ABSTRACT

A consumer who is a member of a computer-implemented loyalty program and who is associated with a first currency, is permitted to redeem loyalty points in exchange for a payment in a second currency which is different from the first currency. The payment may be made in the form of pre-paid physical or virtual payment card, or by a credit to an account held by a mobile wallet server. The consumer is sent information about products which the consumer can purchase using the second currency.

### FIELD OF THE INVENTION

The present disclosure relates to computer-implemented methods and computer systems for operating a loyalty program.

### BACKGROUND OF THE INVENTION

It is common for a merchant to organise a loyalty program for its consumers. Typically, a consumer is provided with a physical loyalty card, which is typically a piece of paper or plastic carrying an account number. The account number is the number of a loyalty account for storing loyalty points earned by the consumer. Whenever the consumer makes a purchase at a point-of-sale (POS) of the merchant they present the loyalty card. Depending on the value of the purchase, the merchant determines a corresponding number of loyalty points, and credits that number of loyalty points to the account associated with the corresponding card. The accumulated loyalty points can be used to obtain rewards, such as goods and/or services (collectively referred to here as “products”) or a discount on a future purchase from the merchant. The advantage of the rewards system for the merchant is that once the consumer has accumulated some loyalty points, he or she is more likely to make future purchases from the same merchant in the hope of eventually earning a reward.

Other loyalty programs are operated by companies other than merchants. For example, sometimes a payment card issuer operates a loyalty program in which consumers are rewarded with loyalty points for making purchases using a payment card. The payment card issuer may offer a range of products which may be obtained using the loyalty points, and/or may permit the payment card holder to convert the loyalty points into loyalty points of a different loyalty program.

Known loyalty programs suffer from a number of disadvantages. Among the reasons commonly given on social media for discontentment with them is a lack of reward relevance (the rewards offered do not fit well with the desires of the consumers).

### SUMMARY OF THE INVENTION

In general terms, the present disclosure proposes that a consumer who is a member of a computer-implemented loyalty program and who is associated with a first currency, is permitted to exchange the consumer's accumulated loyalty points for access to a certain amount of a currency which is different from the first currency (a “second currency”).

The first currency may be one with which the consumer is associated because the consumer is resident in a country where the first currency is the official currency, such as a country having the first currency as legal tender. Alternatively, the first currency may be one associated with at least one payment card held by the consumer, such that balances in an account associated with the payment card are calculated in the first currency.

The option for the consumer to receive a currency payment in exchange for loyalty points makes the loyalty program more useful and therefore attractive to consumers.

The operator of the loyalty program is able to determine the conversion rate at which the loyalty points are converted into the second currency, and ensure that the conversion rate is such that the operator makes a profit on the currency conversion. The result may be more beneficial to the operator of the loyalty program than if the loyalty points are exchanged for a payment to the consumer in the first currency.

The amount of the second currency may be electronically credited to (i.e. made available to the consumer by the issuing to the consumer of a pre-paid payment card (which may be a pre-paid physical payment card) carrying a balance in the second currency, or by incrementing the balance, in the second currency, of an existing pre-paid card. The pre-paid card may be a multicurrency card, such as the “Cash Passport” multicurrency card of Mastercard International Incorporated. The consumer can use the pre-paid payment card to make payment transactions to merchants which accept payment in the second currency, for example because the merchants are located in a jurisdiction having the second currency as the official currency. Typically, the balance (or balances, if the pre-paid card is a multi-purse card such as a multicurrency card) is maintained in a database of a prepaid program management system.

Alternatively, the amount of the second currency may be made available to the consumer by crediting an amount of the second currency to an account associated with the consumer and maintained by a server (sometimes equivalently referred to as a digital wallet server), such that the consumer can make a payment in the second currency using the server. The server may be a mobile wallet server (sometimes equivalently referred to as a digital wallet server, in which case the consumer can make a payment in the second currency using the mobile wallet. Alternatively, the server may provide the consumer with a virtual payment card such that by accessing the server the consumer is electronically sent payment card details (e.g. a PAN number, expiry date and card security code) which can be used to make a payment. The payment card details for the virtual payment card may be different each time this process is carried out.

In one possibility the operator of the loyalty program is also an operator of the mobile wallet server. Indeed, the server which operates the loyalty program may be the same server which operates the mobile wallet server.

Optionally, the consumer may be given the option to convert the reward points into respective amounts of each of a plurality of second currencies using respective conversion rates.

Optionally, the operator of the loyalty program is also an operator of a payment card network, and/or an issuer of payment cards.

Preferably, a prediction is made, using a historic behavior database storing information about prior behavior by the consumer, and in particular prior payment transactions made by the consumer, of the likelihood of the consumer being interested in receiving a payment in a currency other than the first currency in exchange for loyalty points, and/or of which currencies other than the first currency the consumer may be interested in receiving. The consumer may be offered the option of receiving this payment in dependence on the result of the prediction(s).

Preferably, information is transmitted to the consumer describing offers to supply the consumer with products (a term which is used in this document to include both goods and services) in exchange for specified amounts of the second currency.

A prediction may be made, using a historic behavior database storing information about prior behavior by the consumer, and in particular prior payment transactions made by the consumer, of one or more of (i) a time at which the consumer may make a trip to a country employing the second currency, and (ii) one or more categories of products (goods and/or services) which the consumer may be interested in purchasing using the second currency. Using one or both of these predictions, offers to supply the consumer with products in exchange for specified amounts of the second currency may be selected from a database (“a currency offer database”) which stores one or more offers to supply corresponding products in return for a predefined payment in the second currency. The information describing the offers may be transmitted to the consumer at a time selected based on the predicted time at which the consumer makes a trip to the country. Thus, the present disclosure makes it possible to provide the consumer with offers which are relevant, timely and convenient for the consumer.

Conversely, the operator of the loyalty program or the mobile wallet is able to capture a portion of the consumer's spending when outside jurisdictions in which the first currency is used. That is, the operator of the loyalty program or mobile wallet is able to capture a part of the cross border spend.

As used in this document, the term “merchant” refers to an organization which provides products (goods and/or services) to consumers, in exchange for loyalty points of a loyalty program.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Furthermore, the “payment card” may exist only as a data structure (i.e. without physical existence), which is registered with a mobile wallet or cloud wallet.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The disclosure may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

### BRIEF DESCRIPTION OF THE DRAWINGS

An embodiment will now be described for the sake of example only with reference to the following drawings, in which:

FIG. 1 shows schematically a computerized network arranged to perform a method which is an exemplary embodiment;

FIG. 2 is a flow-chart of the method which is an exemplary embodiment; and

FIG. 3 shows schematically the structure of a server which can be used in the computerized network of FIG. 1.

### DETAILED DESCRIPTION OF THE EMBODIMENTS

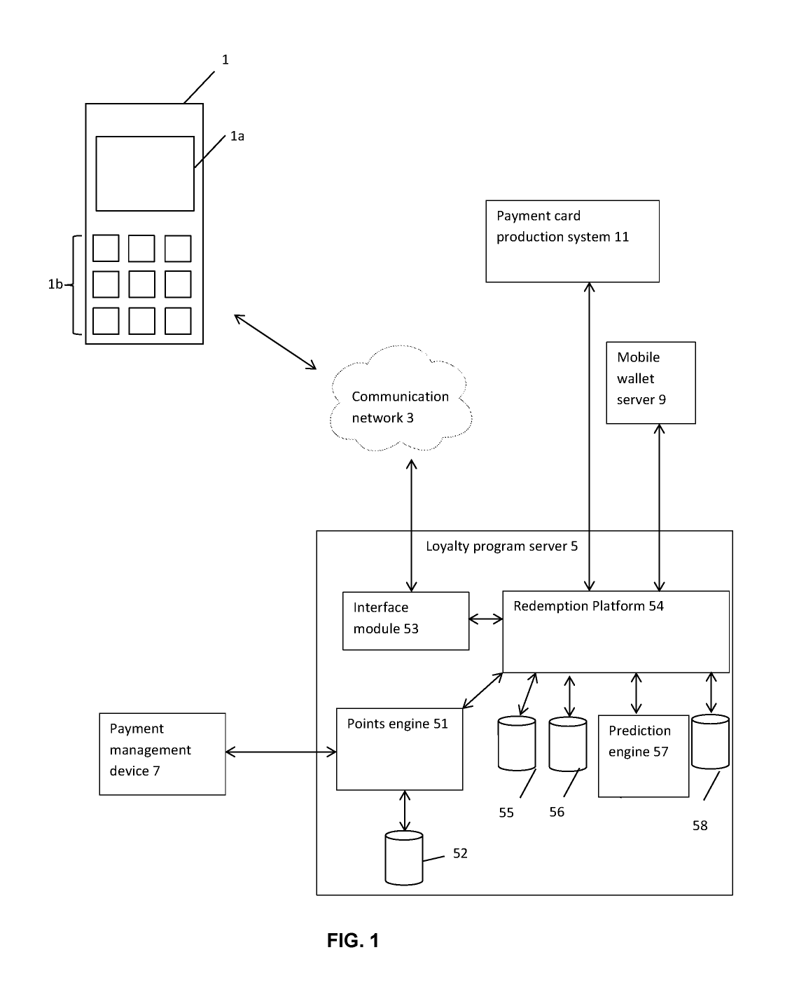

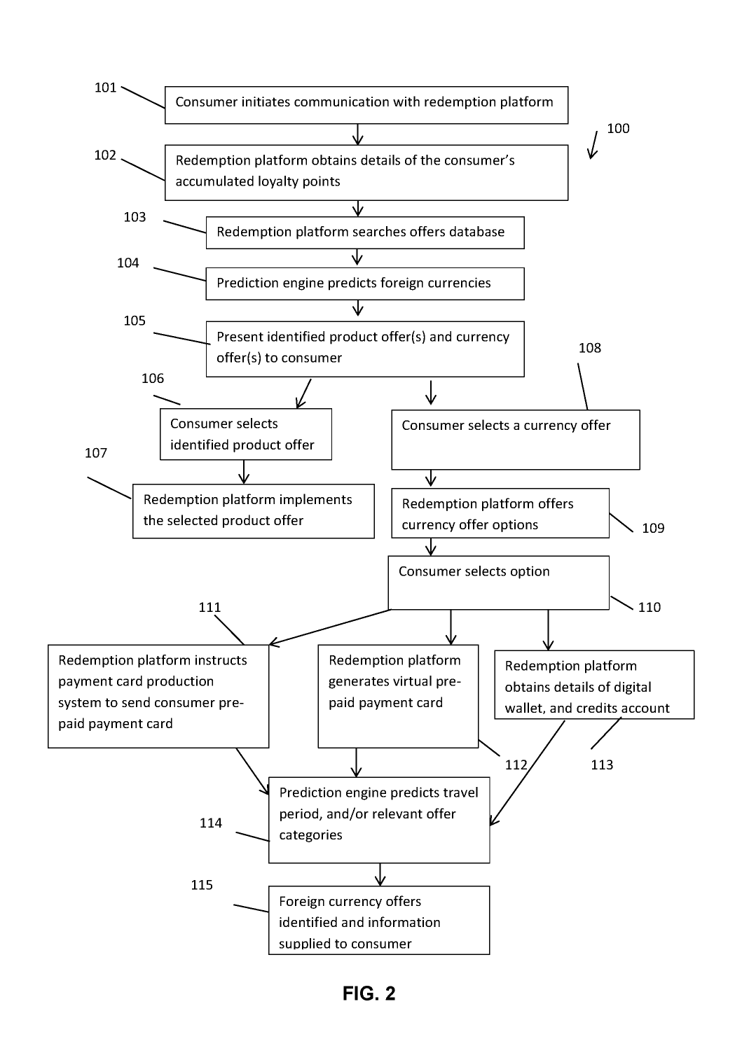

Referring to FIG. 1, a computerized network is shown, comprising a loyalty program server 5 which is an exemplary embodiment. The computerized network can perform a method 100 which is another exemplary embodiment, and which is illustrated in FIG. 2.

The loyalty program server 5 is for operating a loyalty program. Like known loyalty program servers, the loyalty program server 5 includes a points engine 51 which manages respective loyalty accounts for a plurality of consumers. Details of the accounts are stored in an account database 52.

Each of the consumer is associated with a corresponding first currency. For example, if the loyalty program server 5 is provided only for consumers who reside in a particular jurisdiction, the first currency may be the official currency of that jurisdiction, i.e. the same for all consumers. Alternatively, the consumers may be associated with differing corresponding first currencies (e.g. selected from a pre-determined plurality of currencies). Optionally, for a given consumer, a first currency may be associated with the consumer during the procedure in which the loyalty account is created.

As described below, the consumers may be holders of corresponding payment cards, which are associated with respective payment card accounts maintained at a payment card issuing organization (“issuing bank). In this case, the account(s) for a given consumer are typically denominated in the consumer's first currency. If the consumer makes a payment in another currency, then as part of the payment procedure, the payment amount is converted into the first currency and debited from the respective payment card account.

The points engine 51 communicates with one more external payment management devices 7 (for simplicity only one is shown) which provide information to the points engine 51 when a consumer has performed an action which earns points. Using the information, the points engine can determine a corresponding number of points to credit to the consumer's loyalty account. Once the points engine 51 has done this, it credits those points to the corresponding loyalty account in the account database 52.

In one possibility, the payment management device 7 may be a POS terminal located at retail premises where the consumer can make a payment. Optionally, the consumer provides a physical loyalty card when making a purchase to identify the consumer's loyalty account. In another possibility, the payment management device 7 is the server of a merchant which operates an online store where the consumer may make a payment.

In a further possibility, the payment management device 7 may be a server associated with a payment card associated with the consumer. For example, the payment management device 7 may be a server of a payment network associated with the payment card, or a server associated with an issuer bank which issued the payment card. In this case, the payment management device 7 informs the points engine 51 about points earned by the consumer using the payment card. The payment card may be for making payments in the consumer's first currency.

As mentioned above, although only a single payment management device 7 is shown in FIG. 1, in reality there may a plurality of such devices, such that the consumer is able to earn loyalty points by appropriate interaction with any of them. For example, if a consumer makes a purchase using a certain payment card from an online store operated by a merchant server, the merchant server and/or any of the servers associated with the payment card (e.g. a server of the associated payment network and/or a server of the associated issuer bank) may act as the payment management device 7 which transmits information about loyalty points earned to the points engine 51.

Many variations of this arrangement are possible. In one variation, the payment management device 7 may be integrated with the loyalty program server 5, such that a single server manages both payment transactions and the associated loyalty program.

Any given consumer may use a communication device 1 to communicate over a communication network 3 with an interface module 53 of the loyalty program server 5. The communication device 1 includes a screen 1a and one or more data input devices 1b (which may comprise the screen 1a if the screen 1a is touch sensitive). In FIG. 1, the communication device 1 is shown as a smartphone, but it may be another mobile communication device (e.g. a tablet computer), or indeed a personal computer (PC). Although only a single communication device 1 is illustrated in FIG. 1, it is envisaged that the loyalty program server 5 will communicate with a large number of consumers, who each use one or more corresponding communication devices.

The loyalty program server 5 further includes a redemption platform 54. The redemption platform 54 may be in communication with one or both of a mobile wallet server 9 and a pre-paid payment card production system 11.

The mobile wallet server 9 may be of a known kind, for example the MasterPass® system operated by MasterCard International Incorporated. The mobile wallet server 9 is typically operated by a payment card issuer or an organization which is a trusted partner of the card issuer (in existing implementations, the organization may be MasterCard International Incorporated). A payment card holder can register one or more payment card(s) with the mobile wallet server 9. Having done this, the card holder can interact with a participating online merchant using a communication device associated with the card holder. At the check-out stage, the online merchant displays a button on the merchant website which the card holder can click on in order to make a payment using the card holder's mobile wallet. The online merchant then redirects the user to a “switch”, for example one operated by MasterCard International Incorporated. Using a cookie located on the card holder's communication device, the “switch” is able to determine which wallet-hosting server hosts a wallet associated with the card holder. The switch then establishes a connection between the card holder's computer and the appropriate wallet-hosting system, which presents the card holder with a MasterPass sign-in page (e.g. as a pop-up window), where there is an authentication process (e.g. entry of a pre-agreed password). If more than one payment card is associated with the mobile wallet, the consumer chooses one of the payment cards. The wallet-hosting system then securely transfers the card holder's payment and shipping information to the online merchant's domain. The merchant's domain submits the card holder's payment information to an acquiring bank where the merchant holds an account, for a separate authorization process in which the acquiring bank communicates with the issuing bank to ask the bank to authorize the transaction.

The MasterPass system has been extended to in-store payments using a mobile communication device associated with a card holder. Upon the card holder wishing to make a payment, an application on the card holder's mobile device communicates with a point-of-sale (POS) terminal operated by a merchant, and a communication path is established between the mobile device and the mobile wallet server 9. The mobile device sends details of the intended transaction (e.g. the transaction value, and an ID number of the merchant) to the server. If more than one payment card is associated with the mobile wallet, the server asks the card holder to choose one of those payment cards. Upon the consumer choosing, the mobile wallet server 9 passes details of the selected card to the mobile device which forwards them to the POS terminal. The POS terminal takes a payment in the same way in which it would handle a payment transaction using a physical payment card.

The payment card production system 11 is operative to produce pre-paid physical payment cards, and optionally also send them to consumers. The payment card production system may for example be a production device operated by the operator of the loyalty program. Alternatively, it may be a production device operated, and optionally owned, by a party other than the operator of the loyalty program but who has a commercial agreement with the operator of the loyalty program.

As in a conventional loyalty program server, the loyalty program server 5 further comprises an offers database 55 storing product offers to supply corresponding products (a term which is used in this document to mean both products and services) in return for predetermined number of loyalty points (optionally, some of the offers may require loyalty points in combination with a monetary payment by the consumer in the first currency). These product offers are typically provided by corresponding ones of a predetermined set of merchants associated with the loyalty program.

The loyalty program server 5 further comprises a historic behavior database 56 for storing information about the previous behavior of the consumers. This database may be populated in various ways. For example, if one of the payment management devices 7 is associated with one or more payment cards (e.g. if it is operated by a payment network or a payment card issuer), it may supply information about payment transactions to the loyalty program server 5, which may insert the information into the historic behavior database 56. Alternatively or additionally, in the case of a consumer who has registered a payment card with the mobile wallet server 9, the loyalty program server 5 may receive information to populate the historic behavior database 56 from the mobile wallet server 9.

The loyalty program server 5 further includes a prediction engine 57 for making predictions about the behavior of each consumer using information from the historic behavior database 56.

The loyalty program server 5 further includes a foreign currency offers database 58 which stores, for each of a plurality of currencies, one or more offers to supply corresponding products in return for a predefined payment in the currency.

We now turn to an explanation of the method 100. Using the communication device 1, the communication network 3 and the interface module 53, the consumer is able to initiate communication with the redemption platform 54 of the loyalty program server 5 (step 101 of method 100). This may include a log-in procedure, e.g. using a password.

Upon a consumer communicating with the redemption platform 54, the redemption platform communicates with the points engine 51 (step 102) to obtain information about the consumer's account from the account database 52.

As in known loyalty program servers, the redemption platform 54 is able to access the offers database 55 which stores product offers. In step 103, using the number of accumulated points obtained in step 102, the redemption platform 54 searches the offers database 55 (optionally using also data provided by the consumer indicating a product the consumer would like) to identify matching product offers.

In step 104, the prediction engine 57 uses the data in the historic behaviour database 56 to predict one or more foreign currencies (the term “foreign currency” is used here to mean a monetary currency other than the consumer's first currency) in which the consumer may wish to receive a payment. For example, if the data in the historic behaviour database indicates that the consumer has in the past used a payment card to make a payment in a certain foreign currency (e.g. a payment which was converted into the first currency by a forex operation), the prediction engine 57 may predict that the consumer may again wish to make a payment using the same foreign currency. If the historic behaviour database 56 contains no such information, the prediction engine 57 may generate an output indicating that the consumer is not likely to be interested in receiving foreign currency (in this case, step 105, which is explained below, may omit offering the consumer any foreign currency, and the method may not give the consumer the option of the loyalty program server 5 performing steps 108-144). Alternatively, the prediction engine 51 may suggest one or more default foreign currencies which are the currencies consumers most often wish to acquire (e.g. US dollars or euros).

For each of the predicted foreign currencies, the redemption platform uses the number of loyalty points the consumer has accumulated, and a corresponding exchange rate from loyalty points to the predicted foreign currency, to calculate a corresponding maximum amount of the foreign currency which is available using the accumulated loyalty points.

In step 105, the redemption platform 54 transmits data over the interface module 53 and the communication network 3 to the screen 1a of the communication device 1, to instruct the communication device 1 to present to the consumer (i) the product offers identified in step 103, and (ii) an offer to convert some or all of the accumulated loyalty points to the one or more foreign currencies identified in step 104. The offer is referred to here as a currency offer, and may include specifying the calculated maximum amount of each currency available using the accumulated loyalty points. The data transmitted by the redemption platform 54 describing the currency offer is referred to as the “currency offer data”.

In step 106, the consumer may give data input using the data input devices 1b to select one or more of the identified product offers. The communication device 1 transmits this selection to the rewards platform 54.

In step 107, the rewards platform 54 implements the selected product offer(s). Typically, a number of loyalty points specified in the selected product offer are subtracted from the consumer's loyalty account, and a message is sent to the merchant associated with the selected product offer instructing the merchant to supply the product to the consumer.

Alternatively, in step 108, the consumer can enter data input to select at least one currency offer for a respective one of the suggested currencies. Optionally, the consumer may be given an option to request additional currency offers in currencies other than the ones predicted in step 104, and in this case the additional currency offers are presented to the consumer, and the consumer enters data input to select one or more of them. The currency(-ies) of the selected currency offer(s) is/are here referred to as the second currency(-ies).

In step 109, in response to the data input, the redemption platform 54 presents the consumer with a plurality of options relating to the or each selected currency offer.

Firstly, the consumer may be asked how much of the second currency the consumer wants to obtain in exchange for loyalty points (or equivalently, how many of the accumulated loyalty points the consumer wishes to convert into the second currency). The consumer is permitted to make a selection of an amount up to the calculated maximum amount for the second currency. If at stage 108, the consumer selected more than one currency, the maximum amount of each which he is permitted to select at this stage is such that, converting each of the amounts into loyalty points at the respective exchange rate, the sums of the respective number of loyalty points required for the selected amount of each second currency, is no greater than the consumer's accumulated loyalty points according to the database 52.

Furthermore, the consumer may be presented with a plurality of options for respective mechanisms by which the consumer can receive the second currency. These options may include the options of receiving the second currency in the form of a physical pre-paid payment card which the consumer can present to retailers who accept payments in the second currency, or as a virtual payment card, or as a credit to a balance denominated in the second currency in a mobile wallet account associated with the consumer.

The consumer makes selections in step 110 by data input, and the data input is transmitted to the redemption platform 54.

If the consumer specified in step 110 that the foreign currency amount is to be obtained as a prepaid payment card, then in step 111, the redemption platform 5 instructs the payment card production system 11 to fabricate one for the amount specified by the consumer, and either dispatch it directly to the consumer or transmit it to the operator of the loyalty program, so that the operator of the loyalty program can dispatch it to the consumer. The redemption platform also instructs the points engine 51 to update the database 52, to debit a corresponding number of loyalty points from the consumer's account.

If the consumer specified in step 110 that the foreign currency amount is to be obtained as a virtual prepaid payment card, then in step 112, the redemption platform 5 generates the virtual prepaid payment card, for example by communicating with a virtual prepaid payment card server (not shown) which operates a virtual prepaid payment card system to instruct the virtual prepaid payment card server to provide the consumer with a virtual prepaid payment card for the foreign currency amount. The redemption platform also instructs the points engine 51 to update the database 52, to debit a corresponding number of loyalty points from the consumer's account.

If the consumer specified in step 110, that the foreign currency amount is to be obtained via a credit to a mobile wallet, then in step 113 the redemption platform may obtain from the consumer details of the mobile wallet. Alternatively, the details of the mobile wallet may be obtained by a process similar to the conventional mobile wallet operation process described above, e.g. using a cookie stored on the communication device 1. Having obtained the details of the mobile wallet, the redemption platform 54 instructs the mobile wallet server 9 to associate the selected amount of the second currency with the consumer's payment card. In effect, a second account is created associated with the consumer's credit card and denominated in the second currency. Subsequently, if the consumer uses the mobile wallet to make a payment denominated in the second currency, the second account is debited by the amount of the payment. The redemption platform also instructs the points engine 51 to update the database 52, to debit a corresponding number of loyalty points from the consumer's account.

In step 114, the prediction engine 54 uses the data in the historic behavior database 56 to predict the time at which the consumer will make a trip to use the foreign currency. This process may use also the date on which method 100 is being carried out. For example, if the consumer has, according to the data, previously tended to make foreign holidays in mid-July and in December, and if the method 100 is presently being performed in May, then the prediction engine is likely to predict that the consumer intends to use the second currency for a trip in mid-July.

Optionally, the prediction engine 57 may also predict one or more categories of offers in which the consumer may be interested. Each category of offers relates to a category of products (e.g. hotels) and optionally also a price-range. For example, if the data in the historic behavior database 5 indicates that the consumer typically books 5-star hotels when he or she travels, the prediction engine may select a category relating to 5-star hotels, i.e. predict that the consumer is likely to be interested in being offered a deal on such a hotel for the forthcoming trip.

In step 115, the redemption platform 54 searches the foreign currency offers database 58 to identify for offers to supply products in exchange for amounts of the second currency selected in step 108. If, in step 114, the prediction engine 57 predicted a time for the travel, then in step 115 the redemption platform 54 may omit, or be less likely to identify, offers which are not applicable for the predicted time. If in step 114, the prediction engine 57 selected a certain category of offers, the redemption platform 54 may be more likely to identify offers in the predicted category. The redemption platform then arranges for information about the identified offers to be transmitted to the consumer. Optionally, this may be done by email, or via the mobile wallet server 9. The timing at which the information about the offer is transmitted to the consumer may depend on the predicted time of the travel. For example, it may be within a time window which is no more than a first predetermined duration before the predicted date of travel and no less than a second predetermined duration before the predicted date of travel.

Optionally, steps 114 and 115 may only be carried out if a specific one or more of the options are selected in step 100, for example if the consumer selects the mobile wallet option.

In a variation of the embodiment, the foreign currency offers database 58 may be accessible to the mobile wallet server 9, and the mobile wallet server 9, instead of the redemption platform 54, may perform steps 113 and 115 of the method 100.

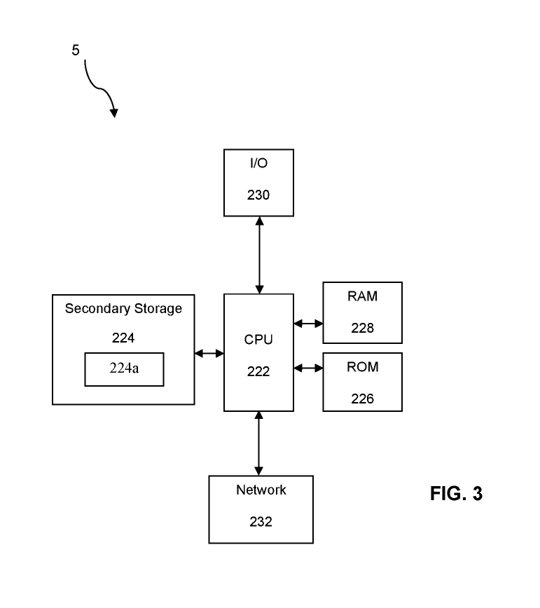

FIG. 3 is a block diagram showing a technical architecture of the loyalty program server 5. The payment network device 7 may also have this technical architecture, as may the mobile wallet server 9. Alternatively, as mentioned above the loyalty program server 5 and one or both of the payment network device 7 and/or the mobile wallet server 9, may be implemented in a single server having the structure of FIG. 3.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a single server (computer), it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A computer-implemented method of operating a loyalty program for a consumer associated with a first currency, the method comprising:
transmitting a currency offer message to a communication device of the consumer, the currency offer message indicating that the consumer can obtain, in exchange for loyalty points of the loyalty program, a payment in one or more currencies which are different from the first currency;
receiving data input from the consumer indicating that the consumer wishes to exchange the loyalty points for a payment in at least one second currency which is one of the one or more currencies which are different from the first currency; and
in response to the data input, electronically crediting a respective amount of the at least one second currency to the consumer, and debiting the loyalty account of the consumer by a corresponding number of loyalty points.

2. A method according to claim 1, in which the currency offer message indicates the maximum amount of each of the one or more currencies which the consumer can obtain in exchange for a number of the loyalty points which the consumer has accumulated in the loyalty program.

3. A method according to claim 1, in which the data input from the consumer indicates the respective amount of each of the at least one second currencies.

4. A method according to claim 1, in which the respective amount of the at least one second currency is electronically credited to the consumer by a process including transmitting a message to a payment card production system, the message instructing the payment card production system to fabricate a pre-paid payment card storing the respective amount of the at least one second currency.

5. A method according to claim 1, in which the respective amount of the at least one second currency is electronically credited to a virtual prepaid payment card account maintained by a server and associated with the consumer.

6. A method according to claim 1, in which the respective amount of the at least one second currency is electronically credited to the consumer in a mobile wallet associated with the consumer and maintained on a mobile wallet server.

7. A method according to claim 1 further comprising selecting the one or more currencies from a predetermined set of currencies other than the first currency based on data describing prior behavior of the consumer.

8. A method according to claim 1 further comprising transmitting to the consumer information describing one or more offers to supply the consumer with corresponding products in exchange for corresponding amounts of the at least one second currency.

9. A method according to claim 8 including (i) forming a prediction, using a historic behavior database storing information about prior behavior by the consumer, of a time at which the consumer may make a trip to a country employing the at least one second currency; (ii) using the predicted time to select a message transmission time; and (ii) at the message transmission time, sending the consumer the information describing the one or more offers.

10. A method according to claim 8, further comprising using a historic behavior database storing information about prior behavior by the consumer, to identify one or more product categories containing products which the consumer may be interested in purchasing, and, using the identified product categories, selecting the information describing the one or more offers from a foreign currency offers database.

11. A computer system for operating a loyalty program, the computer system comprising:
an account database storing data describing respective loyalty accounts for a plurality of consumers, each consumer being associated with a corresponding first currency, and the data indicating a number of loyalty points accumulated in each of the loyalty accounts;
a points engine for updating the account database using information about actions taken by the consumer;
an interface module for managing communications with a communication device of the consumer; and
a redemption platform configured for each of the consumer to:
(i) transmit a currency offer message via the interface module, to a communication device associated with the consumer, the currency offer message indicating that the consumer can obtain, in exchange for loyalty points of the loyalty program, a payment in one or more currencies which are different from the corresponding first currency;
(ii) receive data input from the communication device via the interface module, the data input indicating that the consumer wishes to exchange the loyalty points for a payment in at least one second currency, which is one of the one or more currencies which are different from the first currency and
(iii) in response to the data input, electronically credit a respective amount of the at least one second currency to the consumer, and debit the loyalty account of the consumer by a corresponding number of loyalty points.

12. A computer system according to claim 11, in which the redemption platform is operative to calculate a maximum amount of each of the one or more currencies which the consumer can obtain in exchange for the accumulated loyalty points.

13. A computer system according to claim 11, in which the redemption platform is operative to transmit a message to a payment card production system, the message instructing the payment card production system to fabricate a pre-paid payment card storing the respective amount of the at least one second currency.

14. A computer system according to claim 11, in which the redemption platform is operative to transmit a message to a virtual prepaid payment card server, the message instructing the virtual prepaid payment card server to credit the respective amount of the at least one second currency to a virtual prepaid payment card account associated with the consumer.

15. A computer system according to claim 11, in which the redemption platform is operative to transmit a message to a mobile wallet server, the message instructing the mobile wallet server to credit the respective amount of the at least one second currency to the consumer in a mobile wallet associated with the consumer and maintained on the mobile wallet server.

16. A computer system according to claim 11 further comprising a predictive engine operative to select the one or more currencies from a predetermined set of currencies other than the first currency, based on data describing prior behavior of the consumer.

17. A computer system according to claim 11 further comprising a foreign currency offers database which stores, for each of a plurality of currencies, one or more offers to supply corresponding products in return for a predefined payment in the currency,
the redemption platform being operative to select from the foreign currency offers database offers to supply corresponding products in return for a predefined payment in the at least one second currency, and to transmit to the consumer information describing the offers selected from the foreign currency offers database.

18. A computer system according to claim 17 further comprising using a historic behavior database storing information about prior behavior by the consumer, and a predictive engine operative to identify one or more product categories, the redemption platform being operative to select offers from the currency offer database using the identified product categories.

19. A computer system according to claim 18 further comprising a predictive engine operative to generate a travel date prediction indicative of a travel date of the consumer, based on data describing prior behavior of the consumer.

20. A computer system according to claim 19, in which the redemption offer is operative to transmit the information about the offers selected from the currency offer database, to the consumer with a timing based on the travel date prediction.
